(19) United States
(12) Patent Application Publication
(10) Pub. No.: US 2026/0289828 A1
(43) Pub. Date: Sep. 24, 2026

(54) VIDEO GENERATION

(71) Applicant: Beijing Zitiao Network Technology Co., Ltd., Beijing (CN)

(72) Inventors: Bingchuan Li, Beijing (CN); Lijie Liu, Beijing (CN); Tianxiang Ma, Beijing (CN); Zhuowei Chen, Beijing (CN)

(21) Appl. No.: 19/573,755

(22) Filed: Mar. 20, 2026

(30) Foreign Application Priority Data
Mar. 21, 2025 (CN) 202510346361.X

(51) Int. Cl. G06T 11/00; G06V 10/70; G06V 20/40

(52) U.S. Cl. CPC G06T 11/00; G06V 10/768; G06V 20/46

(57) ABSTRACT

Embodiments of the disclosure provide a method, an apparatus, a device, a storage medium and a program product for video generation. The method includes: obtaining a video generation indication including an input video, at least one reference image, and first description information of a video to be generated, the at least one reference image including at least one subject; determining a visual feature representation set based on a video feature representation corresponding to the input video and an image feature representation corresponding to the at least one reference image; determining a text feature representation set based on a semantic feature representation corresponding to the at least one reference image and a text feature representation corresponding to the first description information; and generating, with an attention mechanism and based on the visual feature representation set and the text feature representation set, a target video including the at least one subject.

### CROSS-REFERENCE

This application claims the priority of Chinese Patent Application No. 202510346361.X, filed on Mar. 21, 2025, entitled “METHOD, APPARATUS, DEVICE, STORAGE MEDIUM AND PROGRAM PRODUCT FOR VIDEO GENERATION”, the entire content of which is incorporated herein by reference.

### FIELD

Example embodiments of the present disclosure generally relate to the field of computers, and in particular, to video generation.

### BACKGROUND

In the field of computer vision (CV), various machine learning-based visual content processing technologies have been significantly developed and widely used. The machine learning-based visual content processing technology may be used in such application scenarios to improve user experience. In some example application scenarios, it is desired to generate visual content (such as an image or a video) matching user input based on user input information, such as text description information.

### SUMMARY

In a first aspect of the present disclosure, a video generation method is provided. The method includes: obtaining a video generation indication, the video generation indication including an input video, at least one reference image, and first description information of a video to be generated, the at least one reference image including at least one subject; determining a visual feature representation set based on a video feature representation corresponding to the input video and an image feature representation corresponding to the at least one reference image; determining a text feature representation set based on a semantic feature representation corresponding to the at least one reference image and a text feature representation corresponding to the first description information; and generating, with an attention mechanism and based on the visual feature representation set and the text feature representation set, a target video including the at least one subject.

In a second aspect of the present disclosure, an apparatus for video generation is provided. The apparatus includes: an obtaining module configured to obtain a video generation indication, the video generation indication including an input video, at least one reference image, and first description information of a video to be generated, the at least one reference image including at least one subject; a first determination module configured to determine a visual feature representation set based on a video feature representation corresponding to the input video and an image feature representation corresponding to the at least one reference image; a second determination module configured to determine a text feature representation set based on a semantic feature representation corresponding to the at least one reference image and a text feature representation corresponding to the first description information; and a generation module configured to generate, with an attention mechanism and based on the visual feature representation set and the text feature representation set, a target video including the at least one subject.

In a third aspect of the present disclosure, an electronic device is provided. The device includes at least one processor; and at least one memory. The at least one memory is coupled to the at least one processor and stores instructions for execution by the at least one processor. The instructions, when executed by the at least one processor, cause the device to perform the method of the first aspect.

In a fourth aspect of the present disclosure, a computer-readable storage medium is provided. The computer-readable storage medium stores computer-executable instructions, the computer-executable instructions are executable by a processor to implement the method of the first aspect.

In a fifth aspect of the present disclosure, a computer program product is provided, including computer-executable instructions, where the computer-executable instructions, when executed by a processor, implement the method of the first aspect.

It should be understood that content described in this summary section is neither intended to identify key or essential features of the embodiments of the present disclosure, nor is it intended to limit the scope of the present disclosure. Other features of the present disclosure will be readily envisaged through the following description.

### BRIEF DESCRIPTION OF DRAWINGS

The above and other features, advantages and aspects of the various embodiments of the present disclosure will become more apparent in combination with the drawings and with reference to the following detailed description. In the drawings, the same or similar reference symbols refer to the same or similar elements, where:

FIG. 1 shows a schematic diagram of an example environment in which the embodiments according to the present disclosure may be implemented;

FIG. 2 shows a schematic diagram of an example architecture for video generation according to some embodiments of the present disclosure;

FIG. 3 shows a schematic diagram of an example structure of a machine learning model for video generation according to some embodiments of the present disclosure;

FIG. 4 shows a schematic diagram of an example architecture of a diffusion model in a training stage according to some embodiments of the present disclosure;

FIG. 5 shows a block diagram of an example process for video generation according to some embodiments of the present disclosure;

FIG. 6 shows a schematic structural block diagram of an example apparatus for video generation according to some embodiments of the present disclosure; and

FIG. 7 shows a block diagram of an electronic device in which one or more embodiments of the present disclosure may be implemented.

### DETAILED DESCRIPTION

The embodiments of the present disclosure will be described in more detail below with reference to the drawings. Although some embodiments of the present disclosure are shown in the drawings, it should be understood that the present disclosure may be implemented in various forms, and should not be construed as being limited to the embodiments set forth herein. Instead, these embodiments are provided for a more thorough and complete understanding of the present disclosure. It should be understood that the drawings and embodiments of the present disclosure are only for example purposes, and are not intended to limit the protection scope of the present disclosure.

In the description of the embodiments of the present disclosure, the term “including” and similar terms should be understood as open-ended inclusions, that is, “including but not limited to”. The term “based on” should be understood as “at least partially based on”. The term “one embodiment” or “the embodiment” should be understood as “at least one embodiment”. The term “some embodiments” should be understood as “at least some embodiments”. The following may also include other explicit and implicit definitions.

Herein, unless explicitly stated, “in response to A” performing a step does not mean that the step is performed immediately after “A”, but may include one or more intermediate steps.

It may be understood that the data involved in the technical solution (including but not limited to the data itself, acquisition or use of the data) should comply with requirements of corresponding laws, regulations and related provisions.

It may be understood that before using the technical solution disclosed in the embodiments of the present disclosure, the user should be informed of the type, range of use, use scenarios, etc. of personal information involved in the present disclosure in an appropriate manner and the authorization of the user should be obtained according to relevant laws and regulations.

For example, in response to receiving an active request from a user, prompt information is sent to the user to clearly prompt the user that the requested operation will require access to and use of the user's personal information, so that the user may independently choose whether to provide the personal information to software or hardware, such as an electronic device, an application, a server or a storage medium, that performs the operations of the technical solution of the present disclosure based on the prompt information.

As an optional but non-limiting implementation, in response to receiving the active request from the user, the prompt information may be sent to the user in the form of, for example, a pop-up window, in which the prompt information may be presented in text. In addition, the pop-up window may also include a selection control for the user to select “agree” or “disagree” to provide the personal information to the electronic device.

It may be understood that the above process of notifying and obtaining user authorization is only illustrative, and does not limit the implementations of the present disclosure. Other manners that satisfy the relevant laws and regulations may also be applied to the implementations of the present disclosure.

As used herein, the term “model” may learn an association between respective inputs and outputs from training data, so that a corresponding output may be generated for a given input after the training is completed. The generation of the model may be based on machine learning techniques. Deep learning is a machine learning algorithm that uses multiple layers of processing units to process inputs and provide corresponding outputs. A neural network model is an example of a model based on deep learning. Herein, a “model” may also be referred to as a “machine learning model”, a “learning model”, a “machine learning network” or a “learning network”, which terms are used interchangeably herein.

A “neural network” is a machine learning network based on deep learning. A neural network may process an input and provide a corresponding output, and generally includes an input layer and an output layer, as well as one or more hidden layers between the input layer and the output layer. Neural networks used in deep learning applications typically include many hidden layers, thereby increasing the depth of the network. The layers of the neural network are connected successively, so that an output of a previous layer is provided as an input of a next layer, where the input layer receives an input of the neural network, and an output of the output layer serves as a final output of the neural network. Each layer of the neural network includes one or more nodes (also referred to as processing nodes or neurons), and each node processes an input from the previous layer.

Generally speaking, machine learning may roughly include three stages, namely, a training stage, a testing stage and an application stage (also referred to as an inference stage). In the training stage, a given model may be trained using a large amount of training data, and parameter values may be continuously iteratively updated until the model may obtain consistent inference from the training data to meet an expected target. Through training, it may be considered that the model may learn an association (also referred to as a mapping from input to output) from input to output from the training data. The parameter values of the trained model is determined. In the testing stage, a test input is applied to the trained model to test whether the model may provide a correct output, thereby determining the performance of the model. In the application stage, the model may be used to process an actual model input based on the parameter values obtained through training, to determine a corresponding model output.

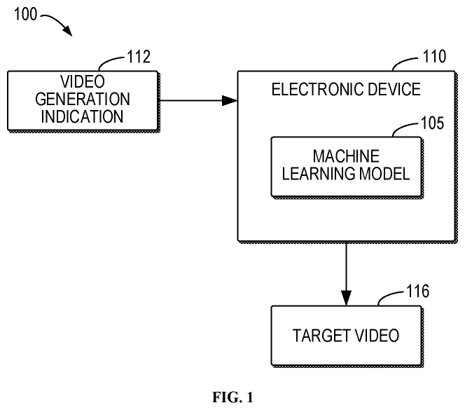

FIG. 1 shows a schematic diagram of an example environment 100 in which the embodiments of the present disclosure can be implemented. As shown in FIG. 1, the environment 100 may include an electronic device 110. In this example environment 100, the electronic device 110 may obtain a video generation indication 112 configured to indicate a requirement of video generation. The video generation indication 112 may include, for example, a prompt, reference visual content such as a video, an image, etc. The electronic device 110 may generate, with a machine learning model 105 and based on the video generation indication 112, a target video 116 corresponding to the video generation indication 112. In some embodiments, the target video 116 may include a subject. The subject may include, for example, a person, an animal, an item, etc.

The machine learning model 105 may be a single model or a combination of multiple models. In some embodiments, the machine learning model 105 may apply an attention mechanism to generate the target video 116. In some embodiments, the machine learning model 105 may be constructed by one or more diffusion models, for example.

A diffusion model, also known as a diffusion probability model, is a class of generative models. This model generates data by simulating a diffusion process. This process is inspired by physical processes such as thermal diffusion. The diffusion model includes a forward diffusion process and a reverse diffusion process. The diffusion model simulates a forward diffusion process of gradually adding noise, and then learns how to reverse this process to generate new data samples.

In the forward diffusion process, noise is gradually added to data, making the data more and more random through a series of steps until the data resembles pure noise. This process may be regarded as a Markov chain. Gaussian noise is added to the data at each step. The forward diffusion process may be expressed as: q(xₜ|xₜ₋₁)= [symbol] (xₜ; \sqrt{αₜ}xₜ₋₁, (1−αₜ)I), where xₜ is noise data at the tth step, and αₜ is configured to control an amount of added noise. The forward diffusion process is executed in model training, and data for adding the noise is a training sample.

In a reverse diffusion process (or a reverse denoising process), the model learns how to reverse the step of adding the noise. Starting from the pure noise, the diffusion model gradually removes the noise to generate data matching a training distribution. The reverse diffusion process is usually simulated using a neural network, which predicts the noise added at each step: p_{θ}(xₜ₋₁|xₜ)= [symbol] (xₜ₋₁; u_{θ}(xₜ, t), σ_{θ}(xₜ, t)), where u_{θ} and σ_{θ} are model parameters obtained through learning. After completing the model training, the model that executes the reverse diffusion process may first start sampling from a noise distribution, and perform iterative denoising, until expected data is obtained.

In the diffusion model, time steps refers to the number of steps for adding the noise in the forward diffusion process. A total number of steps T is usually a predetermined value, which represents how many steps are required for a transformation process from original data to the pure noise. At each time step t, Gaussian noise is added to the data according to a predetermined noise scheme. This process is continuous, and each step depends on a result of a previous step.

When generating data, inference steps of the diffusion model refers to the number of steps required to restore from the pure noise to the original data in the reverse diffusion process. The number of inference steps directly affects quality and speed of the generated data. Generally, the larger the number of inference steps, the higher the quality of the generated data, but this will also increase computing cost and time. In practical applications, a quantity of inference steps may be adjusted to balance generation quality and efficiency. In some embodiments, the inference steps correspond to the time steps, and each inference step may correspond to one or more time steps. For example, if the total number of time steps of the diffusion model is 1000 steps and the number of inference steps is set to 50 steps, each inference step may correspond to 20 time steps.

In the environment 100, the electronic device 110 may be any type of device with a computing capability, including a terminal device or a server device. The terminal device may be any type of mobile terminal, fixed terminal or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a game device, or any combination of the foregoing, including fittings and peripherals of these devices, or any combination thereof. The server device may include, for example, a computing system/server, such as a mainframe, an edge computing node, a computing device in a cloud environment, and so on.

It should be understood that the structures and functions of the elements in the environment 100 are described for illustrative purposes only, without suggesting any limitation to the scope of the present disclosure.

At present, a basic video generation model focuses on two main tasks: text-to-video and image-to-video. Text-to-video (T2V) understand an input text instruction with a language model, and generates visual content describing expected characters, actions, and backgrounds. Although it allows for creative and imaginative content combination, it is often difficult to produce consistently predictable results due to inherent randomness. On the other hand, image-to-video (I2V) usually provides a first frame of an image and an optional text description to convert a static image into a dynamic video. Although it is easier to control, content richness is usually limited by a strict “copy-paste” nature of the first frame. In addition, there is also a need to generate a subject-consistent video, which may be referred to as subject-to-video (S2V). It involves capturing a subject from an image and flexibly generating a video based on a text prompt, while combining diversity and controllability of image and text joint input. The essence of S2V lies in balancing bimodal prompts of text and image, requiring the model to align with both text instructions and image content at the same time.

However, research on subject consistency in the video generation task still lags behind the image generation scenario. With the maturity of the text-to-image (T2I) foundation model, subject-to-image (S2I) has achieved good results from a parameter optimization method to an adapter-based training method and then to a unified image editing method. The most direct way to implement S2V is to combine S2I and I2V, but there are two major limitations. First, compared with S2V, S2I has greater difficulty in learning subject consistency. Because the S2V training data naturally contains multi-view dynamic changes, which enables a better understanding of the subject. Second, transitioning from S2I to I2V may result in information loss. For example, when generating back-to-front view motion, ID information of the subject may be lost due to lack of the ID information in the first frame, which hinders I2V from maintaining ID consistency. Therefore, subject-consistent generation requires a dedicated video model for unified processing.

The rise of diffusion models is rapidly reshaping the field of generative modeling at an amazing speed. Among them, the progress of video generation brought by diffusion models is particularly significant. In the visual field, compared with image generation, video generation needs to pay more attention to continuity and consistency of multiple frames, which brings additional challenges.

In recent years, significant progress has been made in subject-consistent generation for image tasks. Based on optimization-based method training, image content is bound to a special identifier in the text-to-image generation process. A notable work in the training and inference paradigm is IP-Adapter (a text-compatible image prompt adapter capable of generating images based on an image prompt), which freezes weights of a base model while only training an additional adapter to achieve subject-consistent generation. This method is also widely used in tasks that require facial ID consistency. However, these solutions are dependent on extracting image semantics, making it difficult to trade off between detail reconstruction and flexible text response.

At present, progress in video generation capability and algorithm innovation tends to lag behind image tasks. Similar to image consistency technologies, there is currently an optimization-based face ID-consistent video generation method, which requires uploading multiple videos of the same person for optimization, thus incurring huge computing costs. Adapter-based methods have also been tried for video ID consistency tasks. However, these works have been verified on small datasets, which limits their ability to fully align facial information with text descriptions.

Therefore, there is a need for a generation solution that may achieve high-fidelity subject-consistent videos. In addition, such a solution also needs to be able to trade off details of video generation and flexible text response, and reduce computing costs.

In view of this, the embodiments of the present disclosure provide a video generation solution. In this solution, a video generation indication is obtained. The video generation indication includes an input video, at least one reference image, and first description information of a video to be generated. The at least one reference image includes at least one subject. A visual feature representation set is determined based on a video feature representation corresponding to the input video and an image feature representation corresponding to the at least one reference image, A text feature representation set is determined based on a semantic feature representation corresponding to the at least one reference image and a text feature representation corresponding to the first description information. And then, a target video including the at least one subject is generated with an attention mechanism and based on the visual feature representation set and the text feature representation set.

In this way, the embodiments of the present disclosure achieve unified single-subject or multi-subject generation by redesigning a text-image joint injection mechanism and utilizing dynamic feature integration. This solution may achieve high-fidelity subject-consistent video generation. In addition, it is able to trade off the details of video generation and the flexible text response, and reduce the computing cost.

Some example embodiments of the present disclosure will be further described below with reference to the drawings.

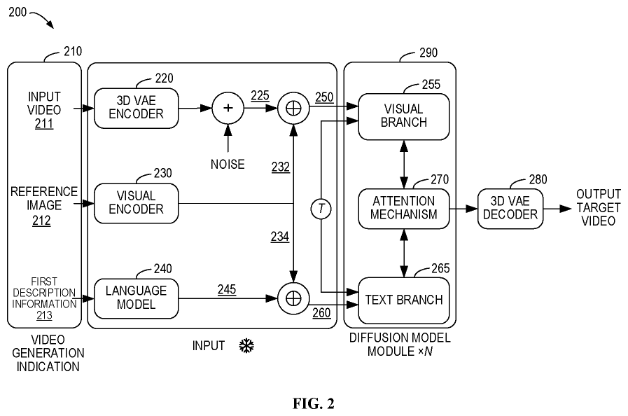

FIG. 2 shows a schematic diagram of an example architecture 200 for video generation according to some embodiments of the present disclosure. For the convenience of discussion, these embodiments will be described with reference to the environment 100 of FIG. 1. These embodiments may be implemented in the electronic device 110 of FIG. 1.

As shown in FIG. 2, the electronic device 110 obtains a video generation indication 210. The video generation indication 210 includes an input video 211, at least one reference image 212, and first description information 213 of a video to be generated. The at least one reference image 212 includes at least one subject.

As an example, the reference image 212 may be an image referred to when a video is generated. The subject may be an object mainly represented and focused on in the reference image 212. As an example, a type of the subject may include but be not limited to a person, a cartoon character, an animal, an item, etc. It should be understood that the subject may be any suitable object that may be focused on and presented in visual content such as an image or a video, which is not limited herein. It may be understood that if the at least one subject includes one subject, the subject may be included in one reference image 212. If the at least one subject includes multiple subjects, the multiple subjects may be included in one reference image 212 or in multiple reference images 212. For example, one video generation indication may include one reference image 212, and the reference image 212 may include two subjects, namely, two girls. Another video generation indication may include two reference images 212, and the two reference images 212 may respectively include one girl.

As an example, the first description information 213 may be configured to describe content of the video to be generated. The described content may include, for example, a scene of the video to be generated, time when the scene occurs, a description of one or more subjects in the video to be generated, etc. The first description information 213 may sometimes be referred to as a prompt.

As an example, the input video 211 may have different functions in a training stage and an inference stage of the machine learning model 105. As an example, the machine learning model 105 may be configured to generate visual content such as an image and a video based on text and an image. It should be understood that the machine learning model 105 may include any model having the capability of text-to-image and image-to-image. In some embodiments, the machine learning model 105 may include a diffusion model. It should be understood that the generation of the visual content based on the text and the image may be implemented through a single diffusion model or a combination of a plurality of diffusion models.

In the model training stage, the input video 211 may be utilized as a truth value for constructing a training loss. For example, in the model training stage, after generating a prediction video based on the video generation indication 210, the machine learning model 105 may define a corresponding training loss based on a difference between the prediction video and the input video 211, to train the machine learning model 105 based on the training loss.

In the model inference stage (which may also be referred to as the application stage), the input video 211 may be, for example, a noise video. That is, in the model inference stage, the target video may be generated based on the at least one reference image 212 and the first description information 213 of the video to be generated.

Further, a video feature representation 225 corresponding to the input video 211, an image feature representation 232 and a semantic feature representation 234 corresponding to the at least one reference image 212, and a text feature representation 245 corresponding to the first description information 213 may be determined. In the disclosed embodiments discussed herein, a feature representation may refer to a representation that is formed after transforming original data, may be understood and processed by the machine learning model 105, and may express a feature of the original data. In the embodiments of the present disclosure, the at least one reference image 212 is converted into the image feature representation 232 and the semantic feature representation 234 from an image dimension and a semantic dimension, respectively.

As an example, a variational autoencoder (VAE) 220 for processing three-dimensional (3D) data may be utilized to determine the video feature representation 225 of the input video 211. After passing through the 3D VAE encoder 220, the input video 211 may be added with noise to obtain the video feature representation 225. When the model iteratively performs training multiple times, noise may be added to the input video 211 in each training process, to gradually train the model. In the inference stage of the model, after the input video 211 is added with noise, it may become white noise, and then the inference of the model is gradually performed.

As an example, a visual encoder 230 may be utilized to determine the image feature representation 232 and the semantic feature representation 234 corresponding to the at least one reference image 212. As an example, the visual encoder 230 may include, for example, a VAE encoder and an image-text multi-modal encoder. The VAE encoder may encode the reference image 212 to provide detailed information of the image. The image-text multi-modal encoder may encode the reference image 212 to provide high-level semantic information of the image.

As an example, a language model 240 may be utilized to determine the text feature representation 245 corresponding to the first description information 213. The language model 240 may be configured to understand semantic information such as a natural language, and generate a corresponding text feature representation.

It should be understood that the above encoders and language models for generating the corresponding feature representations are only examples, without suggesting any limitation. In practical applications, any appropriate type of encoder or model may be used to generate the feature representation of the corresponding data.

Further, the electronic device 110 determines a visual feature representation set 250 based on the video feature representation 225 corresponding to the input video 211 and the image feature representation 232 corresponding to the at least one reference image 212. The electronic device 110 determines a text feature representation set 260 based on the semantic feature representation 234 corresponding to the at least one reference image 212 and the text feature representation 245 corresponding to the first description information 213.

As shown in FIG. 2, the video feature representation 225 and the image feature representation 232 may be concatenated to generate the visual feature representation set 250. The semantic feature representation 234 and the text feature representation 245 may be concatenated to generate the text feature representation set 260.

Taking the machine learning model 105 including a diffusion model as an example, the diffusion model may include a plurality of modules 290. As an example, in each diffusion model module 290, the visual feature representation set 250 may be input into a visual branch 255, and the text feature representation set 260 may be input into a text branch 265.

Further, the electronic device 110 generate, with an attention mechanism 270 and based on the visual feature representation set 250 and the text feature representation set 260, a target video including the at least one subject. The attention mechanism may be applied to the machine learning model 105 such as a diffusion model, to generate the target video.

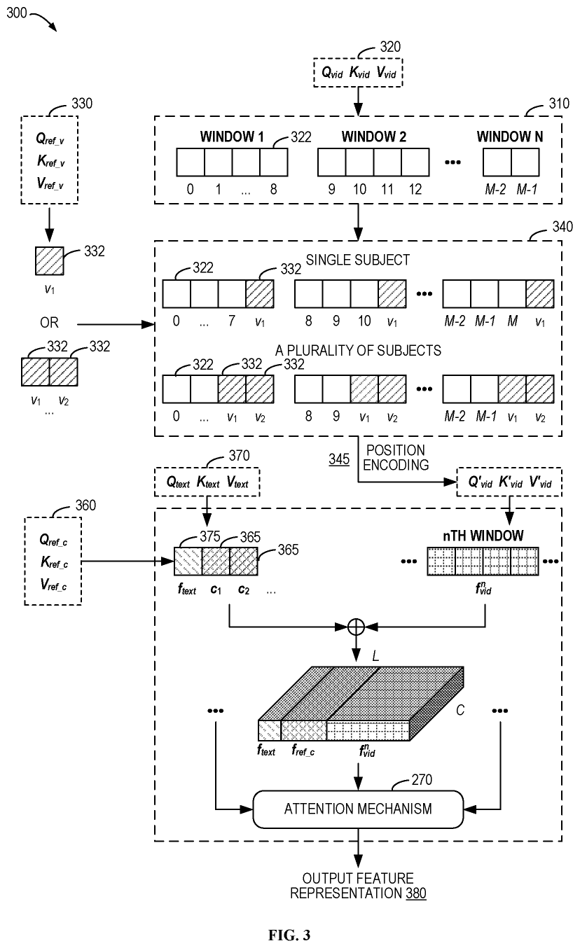

How to utilize the attention mechanism 270 to generate the target video will be discussed in detail below with reference to FIG. 3.

FIG. 3 shows a schematic diagram of an example structure 300 of a machine learning model for video generation according to some embodiments of the present disclosure. The structure 300 may be implemented in the machine learning model 105 in the environment 100 of FIG. 1. Taking the machine learning model 105 being a diffusion model as an example, the structure 300 may be shown as a specific structure of the diffusion model module 290 in the architecture 200 of FIG. 2.

In some embodiments, to generate the target video including the at least one subject, the electronic device 110 may divide a plurality of frames of the input video 211 into a plurality of groups of frames. As an example, each group of frames may correspond to one data window. For example, the a plurality of groups of frames may respectively correspond to Window 1, Window 2, . . . , Window N in block 310.

As an example, each group of frames of the a plurality of groups of frames may correspond to a group of frame feature representations. The group of frame feature representations may include feature representations in the video feature representation 225 that correspond to each frame in the group of frames. A feature representation corresponding to each frame in the video feature representation 225 may be referred to as a frame feature representation.

Further, for each group of frames of the a plurality of groups of frames, the electronic device 110 may determine, based on a group of frame feature representations corresponding to the group of frames in the visual feature representation set 250 and the image feature representation 232, a corresponding combined visual representation in each of a query dimension, a key dimension, and a value dimension. Each feature representation in the embodiments of the present disclosure may be converted into a feature vector representation in the query dimension, the key dimension, and the value dimension.

In some embodiments, to determine the corresponding combined visual representation in each of the query dimension, the key dimension, and the value dimension, for each dimension of the query dimension, the key dimension, and the value dimension: for each frame in the group of frames, the electronic device 110 may determine, based on a frame feature representation of the frame, a frame visual representation 322 of the frame in the dimension. As shown in block 320, a feature vector representation Q_{vid} of each frame in the query dimension, a feature vector representation K_{vid} of each frame in the key dimension, and a feature vector representation V_{vid} of each frame in the value dimension may be determined. Q_{vid}, K_{vid}, and V_{vid} may be individually or collectively referred to as a frame visual representation.

In block 310, each data window may include nine (or any other appropriate number of) frame visual representations 322. It should be understood that the number of frames included in each group of frames may be set according to a specific application, which is not limited herein.

In addition, for each subject of the at least one subject, the electronic device 110 may determine, based on the image feature representation 232 of the reference image 212 including the subject, a subject visual representation 332 of the subject in the dimension. As shown in block 330, a feature vector representation Q_{ref_v} of each subject in the query dimension, a feature vector representation K_{ref_v} of each subject in the key dimension, and a feature vector representation V_{ref_v} of each subject in the value dimension may be determined based on the image feature representation 232. Q_{ref_v}, K_{ref_v}, and V_{ref_v} may be individually or collectively referred to as a subject visual representation.

As an example, if the at least one reference image 212 includes one subject, the image feature representation 232 may correspond to one subject visual representation 332 in each dimension. If the at least one reference image 212 includes a plurality of subjects, the image feature representation 232 may correspond to a plurality of subject visual representations 332 in each dimension.

Then, the frame visual representations 322 respectively determined for the frames in the group of frames and the subject visual representations 332 respectively determined for the at least one subject are combined in a predetermined order, to obtain a combined visual representation of the group of frames in the dimension. In some embodiments, the predetermined order may be an order in which the frame visual representations 322 are arranged before the subject visual representations 332 in each data window. It should be understood that the predetermined order may also be any other appropriate order arranged by the frame visual representations 322 and the subject visual representations 332.

In some embodiments, the number of frames of each group of frames of the plurality of groups of frames may be related to the number of the at least one subject. As an example, a sum of the number of frames of each group of frames and the number of the at least one subject may be equal to a length of the data window. Still taking the length of the data window being 9 as an example, as shown in block 340, for the case of a single subject, the combined visual representation may include eight frame visual representations 322 and one subject visual representation 332. For the case of two (or another number greater than 1) subjects, the combined visual representation may include seven frame visual representations 322 and two subject visual representations 332. In other embodiments, the length of the data window may not be fixed, but dynamically change under certain conditions, which is not limited in the embodiments of the present disclosure.

Further, the electronic device 110 may determine, based on the text feature representation 245 and the semantic feature representation 234 in the text feature representation set 260, a corresponding combined semantic representation in each dimension of the query dimension, the key dimension, and the value dimension. In some embodiments, to determine the corresponding combined semantic representation in each dimension of the query dimension, the key dimension, and the value dimension, for each dimension of the query dimension, the key dimension, and the value dimension, the electronic device 110 may determine, based on the text feature representation 245, a description semantic representation 375 of the first description information 213 in the dimension. For each subject of the at least one subject, the electronic device 110 may determine, based on the semantic feature representation 234 of the reference image 212 including the subject, a subject semantic representation 365 of the subject in the dimension.

As shown in block 370, a feature vector representation Qₜₑₓₜ of the first description information 213 in the query dimension, a feature vector representation Kₜₑₓₜ of the first description information 213 in the key dimension, and a feature vector representation Vₜₑₓₜ of the first description information 213 in the value dimension may be determined. Qₜₑₓₜ, Kₜₑₓₜ, and Vₜₑₓₜ may be individually or collectively referred to as the description semantic representation 375. As shown in block 360, a feature vector representation Q_{ref_c} of each subject in the query dimension, a feature vector representation K_{ref_c} of each subject in the key dimension, and a feature vector representation V_{ref_c} of each subject in the value dimension, may be determined based on the semantic feature representation 234. Q_{ref_c}, K_{ref_c}, and V_{ref_c} may be individually or collectively referred to as the subject semantic representation 365.

As an example, if the at least one reference image 212 includes one subject, the semantic feature representation 234 may correspond to one subject semantic representation 365 in each dimension. If the at least one reference image 212 includes a plurality of subjects, the semantic feature representation 234 may correspond to a plurality of subject semantic representations 365 in each dimension.

Then, the electronic device 110 may combine the description semantic representation 375 and the subject semantic representations 365 respectively determined for the at least one subject, in a predetermined order, to obtain the combined semantic representation in the dimension. In some embodiments, the predetermined order may be an order in which the description semantic representation 375 is arranged before the subject semantic representations 365. It should be understood that the predetermined order may also be any other appropriate order arranged by the description semantic representation 375 and the subject semantic representations 365.

Further, the electronic device 110 may generate the target video by applying the attention mechanism 270 to the corresponding combined semantic representation and the corresponding combined visual representations respectively determined for the plurality of groups of frames. As an example, the attention mechanism 270 may be applied based on a combination of the corresponding combined visual representation and the corresponding combined semantic representation after position encoding (345) is performed, to generate the target video. As an example, the position encoding may include, for example, 3D rope encoding or any other appropriate position encoding. The attention mechanism 270 may also be referred to as a window self-attention (Window Self Attention) mechanism.

In this way, for each dimension of the query dimension, the key dimension, and the value dimension, after combining the positionally encoded combined visual representation of the dimension corresponding to each data window (for example, the nth window) with the combined semantic representation of the dimension, the attention mechanism 270 may be utilized to output a combined feature representation 380.

Referring back to FIG. 2, as an example, the combined feature representation 380 may be input to a 3D VAE decoder 280, to output the target video. As an example, the 3D VAE decoder 280 may correspond to the 3D VAE encoder.

With reference to FIGS. 2 and 3, as discussed above, the visual encoder 230 includes a variational autoencoder (VAE) and an image-text multi-modal model. The image is featured with Fref_v, which is connected with the video latent Fvid to obtain a concatenated feature FV. This may reuse the 3D VAE to keep the consistency of visual branch input. Meanwhile, the image-text multi-modal feature Fref_c of the image is connected with the text feature Ftext to obtain a concatenated feature FT. This provides high-level semantic information, compensating for the low-level features of the VAE. It should be understood that feature merging involves dimension alignment, that is, merging of the corresponding feature representations is performed according to the query dimension, the key dimension, and the value dimension. Then, the concatenated features FT and FV may be input into the visual branch 255 and the text branch 265 of the diffusion model module 290, and the model only separates the injected features when calculating the attention. Specifically, the diffusion model module 290 is based on and improved for the reference image input, and the attention module is mainly modified. First, the Q_{vid}, K_{vid}, V_{vid} feature calculated according to Fvid is divided into windows of size 9. Then, the Q_{ref_v}, K_{ref_v}, V_{ref_v} calculated according to Fref_v is dynamically connected to the end of each window, while the in-situ features are sequentially moved to the beginning of the next window. This approach maintains the window structure while ensuring the interaction between video and subject features within each window, as well as adaptive input of single or a plurality of subjects. Meanwhile, features such as the Qₜₑₓₜ, Kₜₑₓₜ, Vₜₑₓₜ feature calculated according to Ftext and the Q_{ref_c}, K_{ref_c}, V_{ref_c} calculated according to Fref_c are dynamically concatenated in series. After collecting all reference information, each window is calculated. Then, the dynamically injected reference image features (including ref_v and ref_c) and the text feature in each window are extracted from the output features and averaged. This process ensures that the dimensions of the input features and output features in the current module remain consistent, thereby facilitating subsequent module calculation.

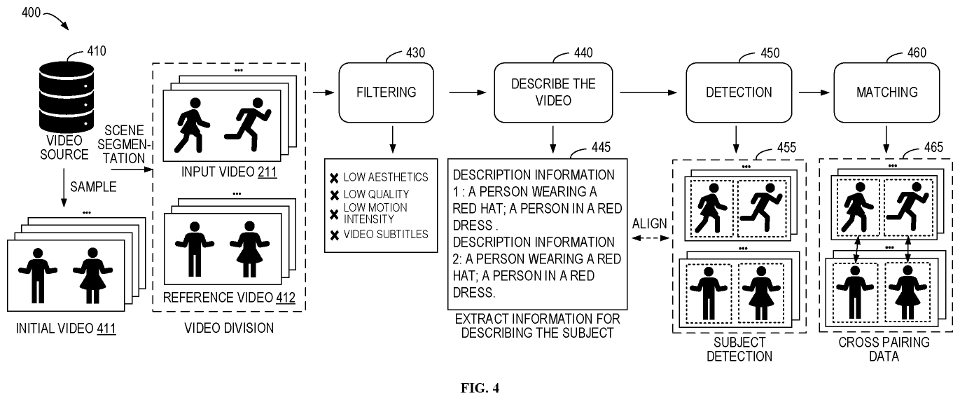

In some embodiments, the embodiment implemented with the architecture 200 may be executed in the training of the diffusion model based on the attention mechanism 270. The training process of the diffusion model will be discussed in detail below with reference to FIG. 4.

FIG. 4 shows a schematic diagram of an example architecture 400 of a diffusion model in a training stage according to some embodiments of the present disclosure. The architecture 400 may be implemented in the environment 100 of FIG. 1. The training of the diffusion model may be implemented locally at the electronic device 110 or at another device/system.

In some embodiments, the video generation indication 210 may include a training sample obtained as follows. The electronic device 110 may divide an initial video 411 into the input video 211 and a reference video 412 different from the input video 211. The initial video 411 may be from a video source 410.

In some embodiments, a first scene corresponding to the reference video 412 may be different from a second scene corresponding to the input video 211. For example, the first scene corresponding to the reference video 412 may be a scene of two people talking. The second scene corresponding to the input video 211 may be a scene of two people running. By intercepting video clips of different scenes, the effectiveness of scene-related texts may be improved and content diversity may be increased.

As an example, filtering (430) may be performed on the selected input video 211 and the selected reference video 412. In the filtering process, a video clip with low aesthetics, low quality, low motion intensity, and video subtitles may be removed. The video clip with low motion intensity may include, for example, a clip with a small motion amplitude of the subject.

Further, the electronic device 110 may extract the at least one reference image from the reference video 412 by performing subject detection 450 on the input video 211 and the reference video 412. Then, the electronic device 110 may construct the training sample based on the at least one reference image, the input video 211, and description information for the input video 211.

In some embodiments, to extract the at least one reference image from the reference video, the electronic device 110 may generate, with a multi-modal model, the first description information for the input video 211 and second description information for the reference video 412. As an example, the multi-modal model may be configured to understand text and visual content, and generate at least corresponding text description information. The multi-modal model may include, for example, a vision-language model, or any other appropriate type of model that may understand text and visual content and generate at least text description information.

In some embodiments, the first description information and the second description information may respectively include a description of the subject and a description of the scene in the corresponding video. As an example, the description of the subject may include, for example, a description of an appearance and a gesture (or behavior) of the subject.

Further, the electronic device 110 may detect (450) whether there is a matching subject word in the first description information and the second description information. As an example, a language model may be utilize to determine whether there is a matching subject word by extracting description information about the subject in the first description information and the second description information. For example, in block 445, description information 1 may be extracted from the first description information, and description information 2 may be extracted from the second description information. It may be detected whether two subject words, namely, “a person wearing a red hat” and “a person in a red dress” in the description information 1 match two subject words, namely, “a person wearing a red hat” and “a person in a red dress” in the description information 2.

In some embodiments, if the matching subject words are detected, the electronic device 110 may extract the at least one reference image from the reference video 412 based on the matching subject words. As an example, the subject in the input video 211 and the subject in the reference video 412 may be located in corresponding video frames by detection boxes. In this way, the multi-modal model may be utilize to align the subject in the detection box with the subject word in the description information. Then, the subject in the input video 211 and the subject in the reference video 412 may be matched (460) according to the detection boxes. Further, the at least one subject may be determined from the reference video 412, and the at least one reference image including the at least one subject may be extracted. As an example, in order to make the subject in the reference image prominent, each subject may be intercepted from the video frame to generate a corresponding reference image.

In some embodiments, the embodiment implemented with the architecture 200 may be executed in the inference stage. The first description information may be originated from a user input. In some embodiments, using the language model, the electronic device 110 may determine whether the first description information meets a predetermined requirement. The predetermined requirement may at least indicate a description of an appearance and a gesture of the at least one subject. For example, for the subject such as a person, the first description information may include, for example, a color of clothes the person is wearing, a body gesture of the person, etc. For another example, for the subject such as an animal, the first description information may include, for example, a color of fur of the animal, a body gesture of the animal, etc.

Further, if the first description information fails to meet the predetermined requirement, the electronic device 110 may update the first description information based on the predetermined requirement. That is, if the first description information input by the user lacks the description of an appearance and a gesture of the at least one subject, the first description information may be rewritten to enable the first description information to meet the predetermined requirement. In this way, by ensuring that the first description information is capable of accurately describing an appearance and a gesture of each subject, confusion of similar subjects may be avoided.

Through the embodiments of the present disclosure, an adaptive injection mechanism is developed to dynamically determine the priority of the text or image condition according to task requirements, thereby reducing content leakage and improving text responsiveness, and enhancing cross-modal alignment. In addition, multi-subject interaction may be better simulated and a consistent relative scale may be implemented. Dataset bias and model bias is alleviated through an adversarial debiasing technique and synthetic data augmentation for underrepresented subjects. This subject-consistent video generation method achieves cross-modal alignment through text-image-video triplet learning. By redesigning the text-image joint injection mechanism and utilizing dynamic feature integration, it demonstrates competitive performance in unified single/multi-subject generation and face ID preservation tasks.

### Example Process

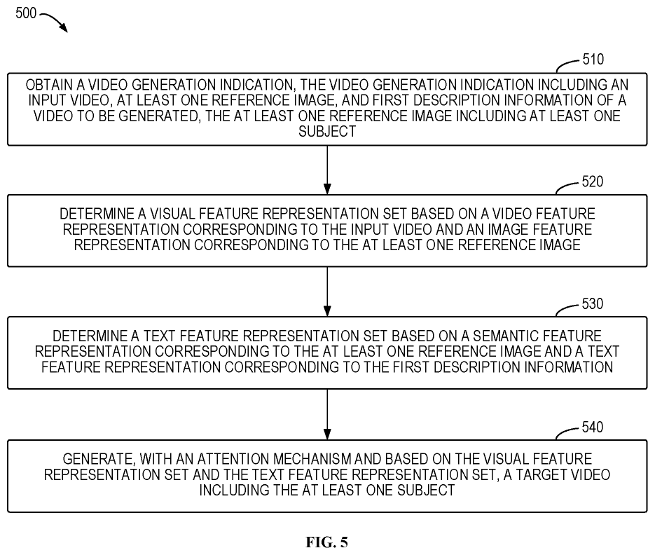

FIG. 5 shows a flowchart of an example process 500 for video generation according to some embodiments of the present disclosure. The process 500 may be implemented at the electronic device 110. The process 500 is described below with reference to FIG. 1.

As shown in FIG. 5, at block 510, the electronic device 110 obtains a video generation indication, the video generation indication including an input video, at least one reference image, and first description information of a video to be generated, the at least one reference image including at least one subject.

At block 520, the electronic device 110 determines a visual feature representation set based on a video feature representation corresponding to the input video and an image feature representation corresponding to the at least one reference image.

At block 530, the electronic device 110 determines a text feature representation set based on a semantic feature representation corresponding to the at least one reference image and a text feature representation corresponding to the first description information.

At block 540, the electronic device 110 generates, with an attention mechanism and based on the visual feature representation set and the text feature representation set, a target video including the at least one subject.

In some embodiments, generating the target video including the at least one subject includes: dividing a plurality of frames of the input video into a plurality of groups of frames; determining, for each group of frames of the plurality of groups of frames, a corresponding combined visual representation in each of a query dimension, a key dimension, and a value dimension based on the image feature representation and a group of frame feature representations corresponding to the group of frames in the visual feature representation set; determining a corresponding combined semantic representation in each of the query dimension, the key dimension, and the value dimension based on the text feature representation and the semantic feature representation in the text feature representation set; and generating the target video by applying the attention mechanism to the corresponding combined semantic representation and the corresponding combined visual representations determined respectively for the plurality of groups of frames.

In some embodiments, determining the corresponding combined visual representation in each of the query dimension, the key dimension, and the value dimension includes: for each dimension of the query dimension, the key dimension, and the value dimension: determining, for each frame in the group of frames and based on a frame feature representation of the frame, a frame visual representation of the frame in the dimension; determining, for each subject of the at least one subject and based on an image feature representation of a reference image including the subject, a subject visual representation of the subject in the dimension; and combining, in a predetermined order, the frame visual representations respectively determined for the group of frames and the subject visual representations respectively determined for the at least one subject, to obtain a combined visual representation of the group of frames in the dimension.

In some embodiments, determining the corresponding combined semantic representation in each of the query dimension, the key dimension, and the value dimension includes: for each dimension of the query dimension, the key dimension, and the value dimension: determining, based on the text feature representation, a description semantic representation of the first description information in the dimension; determining, for each subject of the at least one subject and based on a semantic feature representation of a reference image including the subject, a subject semantic representation of the subject in the dimension; and combining, in a predetermined order, the description semantic representation and the subject semantic representations respectively determined for the at least one subject, to obtain a combined semantic representation in the dimension.

In some embodiments, the number of frames of each group of frames of the plurality of groups of frames is related to the number of the at least one subject.

In some embodiments, the method is performed in training of a diffusion model based on the attention mechanism, and the video generation indication includes a training sample obtained by: dividing an initial video into the input video and a reference video different from the input video; extracting, by performing subject detection on the input video and the reference video, the at least one reference image from the reference video; and constructing the training sample based on the at least one reference image, the input video, and description information for the input video.

In some embodiments, a first scene corresponding to the reference video is different from a second scene corresponding to the input video.

In some embodiments, extracting the at least one reference image from the reference video includes: generating, with a multi-modal model, the first description information for the input video and second description information for the reference video, the first description information and the second description information respectively including a description of a subject and a description of a scene in the corresponding video; detecting whether there is a matching subject word in the first description information and the second description information; and extracting, in response to detecting the matching subject word, the at least one reference image from the reference video based on the matching subject word.

In some embodiments, the method is performed in an inference stage, the first description information originates from a user input, and the method further includes: determining, with a language model, whether the first description information meets a predetermined requirement, the predetermined requirement at least indicating a description of an appearance and a gesture of the at least one subject; and updating, in response to the first description information failing to meet the predetermined requirement, the first description information based on the predetermined requirement.

### Example Apparatus and Device

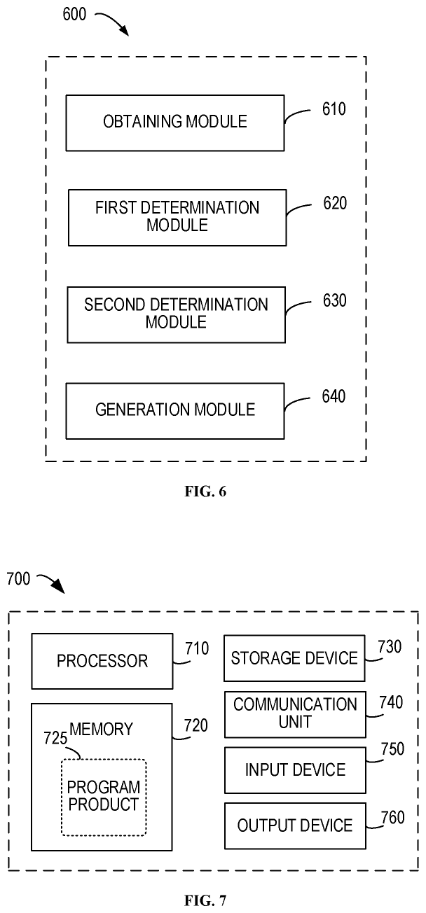

The embodiments of the present disclosure further provide a corresponding apparatus for implementing the above method or process. FIG. 6 shows a schematic structural block diagram of an example apparatus 600 for video generation according to some embodiments of the present disclosure. The apparatus 600 may be implemented as the electronic device 110 or included in the electronic device 110. Each module/component in the apparatus 600 may be implemented by hardware, software, firmware, or any combination thereof.

As shown in the figure, the apparatus 600 includes: an obtaining module 610 configured to obtain a video generation indication, the video generation indication including an input video, at least one reference image, and first description information of a video to be generated, the at least one reference image including at least one subject; a first determination module 620 configured to determine a visual feature representation set based on a video feature representation corresponding to the input video and an image feature representation corresponding to the at least one reference image; a second determination module 630 configured to determine a text feature representation set based on a semantic feature representation corresponding to the at least one reference image and a text feature representation corresponding to the first description information; and a generation module 640 configured to generate, with an attention mechanism and based on the visual feature representation set and the text feature representation set, a target video including the at least one subject.

In some embodiments, the generation module 640 is configured to: divide a plurality of frames of the input video into a plurality of groups of frames; determine, for each group of frames of the plurality of groups of frames, a corresponding combined visual representation in each of a query dimension, a key dimension, and a value dimension based on the image feature representation and a group of frame feature representations corresponding to the group of frames in the visual feature representation set; determine a corresponding combined semantic representation in each of the query dimension, the key dimension, and the value dimension based on the text feature representation and the semantic feature representation in the text feature representation set; and generate the target video by applying the attention mechanism to the corresponding combined semantic representation and the corresponding combined visual representations determined respectively for the plurality of groups of frames.

In some embodiments, the generation module 640 is configured to: determine, for each frame in the group of frames and based on a frame feature representation of the frame, a frame visual representation of the frame in the dimension; determine, for each subject of the at least one subject and based on an image feature representation of a reference image including the subject, a subject visual representation of the subject in the dimension; and combining, in a predetermined order, the frame visual representations respectively determined for the group of frames and the subject visual representations respectively determined for the at least one subject, to obtain a combined visual representation of the group of frames in the dimension.

In some embodiments, the generation module 640 is configured to: determine, based on the text feature representation, a description semantic representation of the first description information in the dimension; determine, for each subject of the at least one subject and based on a semantic feature representation of a reference image including the subject, a subject semantic representation of the subject in the dimension; and combine, in a predetermined order, the description semantic representation and the subject semantic representations respectively determined for the at least one subject, to obtain a combined semantic representation in the dimension.

In some embodiments, the number of frames of each group of frames of the plurality of groups of frames is related to the number of the at least one subject.

In some embodiments, the apparatus 600 is an apparatus for training a diffusion model based on attention mechanism, and the video generation indication includes a training sample obtained by: divide an initial video into the input video and a reference video different from the input video; extract, by performing subject detection on the input video and the reference video, the at least one reference image from the reference video; and construct the training sample based on the at least one reference image, the input video, and description information for the input video.

In some embodiments, a first scene corresponding to the reference video is different from a second scene corresponding to the input video.

In some embodiments, extracting the at least one reference image from the reference video includes: generate, with a multi-modal model, the first description information for the input video and second description information for the reference video, the first description information and the second description information respectively including a description of a subject and a description of a scene in the corresponding video; detect whether there is a matching subject word in the first description information and the second description information; and extract, in response to detecting the matching subject word, the at least one reference image from the reference video based on the matching subject word.

In some embodiments, the apparatus 600 is an apparatus used in an inference stage, the first description information originates from a user input, and the apparatus 600 is further configured to: determine, with a language model, whether the first description information meets a predetermined requirement, the predetermined requirement at least indicating a description of an appearance and a gesture of the at least one subject; and update, in response to the first description information failing to meet the predetermined requirement, the first description information based on the predetermined requirement.

The units and/or modules included in the apparatus 600 may be implemented in various ways, including software, hardware, firmware, or any combination thereof. In some embodiments, one or more units and/or modules may be implemented using software and/or firmware, such as machine-executable instructions stored on a storage medium. In addition to machine-executable instructions or as an alternative, a part of or all of units and/or modules in the apparatus 600 may be implemented at least partially by one or more hardware logic components. As an example, rather than a limitation, example types of hardware logic components that may be used include field programmable gate array (FPGA), application specific integrated circuit (ASIC), application specific standard parts (ASSP), system on chips (SOC), complex programmable logic device (CPLD), and so on.

FIG. 7 shows a block diagram of an electronic device 700 in which one or more embodiments of the present disclosure may be implemented. It should be understood that the electronic device 700 shown in FIG. 7 is only illustrative, and should not constitute any limitation on the functions and scope of the embodiments described herein. The electronic device 700 shown in FIG. 7 may include or be implemented as the electronic device 110 in FIG. 1 or the apparatus 600 in FIG. 6.

As shown in FIG. 7, the electronic device 700 is in a form of a general electronic device. Components of the electronic device 700 may include, but are not limited to, one or more processors or processors 710, a memory 720, a storage device 730, one or more communication units 740, one or more input devices 750, and one or more output devices 760. The processor 710 may be an actual or virtual processor, and may execute various processes based on executable instructions stored in the memory 720. In a multi-processor system, multiple processors execute computer-executable instructions in parallel, to improve a parallel processing capability of the electronic device 700.

The electronic device 700 typically includes multiple computer storage medium. Such medium may be any available medium accessible by the electronic device 700, including, but not limited to, volatile and non-volatile medium, removable and non-removable medium. The memory 720 may be volatile memory (for example, a register, cache, a random access memory (RAM)), a non-volatile memory (for example, a read-only memory (ROM), an electrically erasable programmable read-only memory (EEPROM), a flash memory), or any combination thereof. The storage device 730 may be any removable or non-removable medium, and may include a machine-readable medium, such as a flash drive, a disk, or any other medium, which may be used to store information and/or data and may be accessed within the electronic device 700.

The electronic device 700 may further include a further removable/non-removable, volatile/non-volatile memory medium. Although not shown in FIG. 7, a disk driver for reading from or writing to a removable, non-volatile disk (such as a “floppy disk”), and an optical disk driver for reading from or writing to a removable, non-volatile optical disk may be provided. In these cases, each driver may be connected to a bus (not shown) by one or more data medium interfaces. The memory 720 may include a computer-executable instructions product 725, which has one or more executable instruction modules configured to perform various methods or acts of the various embodiments of the present disclosure.

The communication unit 740 implements communication with other electronic devices through a communication medium. Additionally, the functions of the components of the electronic device 700 may be implemented by a single computing cluster or multiple computing machines, which may communicate through communication connections. Therefore, the electronic device 700 may use a logical connection with one or more other servers, a network personal computer (PC), or another network node to operate in a networked environment.

The input device 750 may be one or more input devices, such as a mouse, a keyboard, a tracking ball, etc. The output device 760 may be one or more output devices, such as a display, a speaker, a printer, etc. The electronic device 700 may further communicate with one or more external devices (not shown) through the communication unit 740 as needed (the external devices such as a storage device, a display device, etc.); communicate with one or more devices that enable a user to interact with the electronic device 700, or communicate with any devices (for example, a network card, a modem, etc.) that enable the electronic device 700 to communicate with one or more other electronic devices. Such communication may be performed via input/output (I/O) interfaces (not shown).

According to an example implementation of the present disclosure, a computer-readable storage medium is provided, storing computer-executable instructions thereon, where the computer-executable instructions are executed by a processor to implement the method described above. According to an illustrative implementation of the present disclosure, a computer-executable instructions product is further provided. The computer-executable instructions product is tangibly stored on a non-transitory computer-readable medium and includes computer-executable instructions, and the computer-executable instructions are executed by a processor to implement the method described above.

Various aspects of the present disclosure are described herein with reference to flowcharts and/or block diagrams of methods, apparatuses, devices and computer-executable instructions products implemented according to the present disclosure. It should be understood that each block of the flowchart and/or block diagram, and combinations of the blocks in the flowchart and/or block diagram may be implemented by computer-readable and computer-executable instructions.

These computer-executable instructions may be provided to a processor of a general-purpose computer, a special-purpose computer, or other programmable data processing apparatus to produce a machine, such that when the instructions are executed by the processor of the computer or other programmable data processing apparatus, an apparatus for implementing the functions/acts specified in one or more blocks of the flowchart and/or block diagram is produced. These computer-executable instructions may also be stored in a computer-readable storage medium, and these instructions cause the computer, the programmable data processing apparatus, and/or other devices to work in a particular manner, so that the computer-readable medium storing instructions includes an article of manufacture, which includes instructions for implementing various aspects of the functions/acts specified in one or more blocks of the flowchart and/or block diagram.

The computer-executable instructions may be loaded onto a computer, another programmable data processing apparatus, or other devices, such that a series of operations and steps are performed on the computer, the other programmable data processing apparatus, or other devices, to produce a computer-implemented process, so that the instructions executed on the computer, the other programmable data processing apparatus, or other devices implement the functions/acts specified in one or more blocks of the flowchart and/or block diagram.

The flowchart and block diagram in the drawings show the possibly implemented architectures, functions, and operations of the systems, methods and computer-executable instructions products according to multiple implementations of the present disclosure. In this regard, each block in the flowchart or block diagram may represent a module, executable instructions, or a part of instructions, and the module, the executable instructions, or the part of instructions contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagram and/or the flowchart, and the combination of the blocks in the block diagram and/or the flowchart may be implemented by a special-purpose hardware-based system that executes specified functions or acts, or may be implemented by a combination of special-purpose hardware and computer instructions.

The implementations of the present disclosure have been described above, and the above description is illustrative, non-exhaustive, and not limited to the disclosed implementations. Many modifications and variations will be apparent to those of ordinary skill in the art without departing from the scope of the described implementations. The terms used herein are chosen to best explain the principles of the implementations, the practical applications or improvements to the technology in the market, or to enable other those of ordinary skill in the art to understand the implementations disclosed herein.

1. A method of video generation, comprising:
obtaining a video generation indication, the video generation indication comprising an input video, at least one reference image, and first description information of a video to be generated, the at least one reference image comprising at least one subject;
determining a visual feature representation set based on a video feature representation corresponding to the input video and an image feature representation corresponding to the at least one reference image;
determining a text feature representation set based on a semantic feature representation corresponding to the at least one reference image and a text feature representation corresponding to the first description information; and
generating, with an attention mechanism and based on the visual feature representation set and the text feature representation set, a video comprising the at least one subject.

2. The method of claim 1, wherein generating the video comprising the at least one subject comprises:
dividing a plurality of frames of the input video into a plurality of groups of frames;
determining, for each group of frames of the plurality of groups of frames, a corresponding combined visual representation in each of a query dimension, a key dimension, and a value dimension based on the image feature representation and a group of frame feature representations corresponding to the group of frames in the visual feature representation set;
determining a corresponding combined semantic representation in each of the query dimension, the key dimension, and the value dimension based on the text feature representation and the semantic feature representation in the text feature representation set; and
generating the video by applying the attention mechanism to the corresponding combined semantic representation and the corresponding combined visual representations determined respectively for the plurality of groups of frames.

3. The method of claim 2, wherein determining the corresponding combined visual representation in each of the query dimension, the key dimension, and the value dimension comprises: for each dimension of the query dimension, the key dimension, and the value dimension:
determining, for each frame in the group of frames and based on a frame feature representation of the frame, a frame visual representation of the frame in the dimension;
determining, for each subject of the at least one subject and based on an image feature representation of a reference image comprising the subject, a subject visual representation of the subject in the dimension; and
combining, in a predetermined order, the frame visual representations respectively determined for the group of frames and the subject visual representations respectively determined for the at least one subject, to obtain a combined visual representation of the group of frames in the dimension.

4. The method of claim 2, wherein determining the corresponding combined semantic representation in each of the query dimension, the key dimension, and the value dimension comprises: for each dimension of the query dimension, the key dimension, and the value dimension:
determining, based on the text feature representation, a description semantic representation of the first description information in the dimension;
determining, for each subject of the at least one subject and based on a semantic feature representation of a reference image comprising the subject, a subject semantic representation of the subject in the dimension; and
combining, in a predetermined order, the description semantic representation and the subject semantic representations respectively determined for the at least one subject, to obtain a combined semantic representation in the dimension.

5. The method of claim 2, wherein the number of frames of each group of frames of the plurality of groups of frames is related to the number of the at least one subject.

6. The method of claim 1, wherein the method is performed in training of a diffusion model based on the attention mechanism, and the video generation indication comprises a training sample obtained by:
dividing an initial video into the input video and a reference video different from the input video;
extracting, by performing subject detection on the input video and the reference video, the at least one reference image from the reference video; and
constructing the training sample based on the at least one reference image, the input video, and description information for the input video.

7. The method of claim 6, wherein a first scene corresponding to the reference video is different from a second scene corresponding to the input video.

8. The method of claim 6, wherein extracting the at least one reference image from the reference video comprises:
generating, with a multi-modal model, the first description information for the input video and second description information for the reference video, the first description information and the second description information respectively comprising a description of a subject and a description of a scene in the corresponding video;
detecting whether there is a matching subject word in the first description information and the second description information; and
extracting, in response to detecting the matching subject word, the at least one reference image from the reference video based on the matching subject word.

9. The method of claim 1, wherein the method is performed in an inference stage, the first description information originates from a user input, and the method further comprises:
determining, with a language model, whether the first description information meets a predetermined requirement, the predetermined requirement at least indicating a description of an appearance and a gesture of the at least one subject; and
updating, in response to the first description information failing to meet the predetermined requirement, the first description information based on the predetermined requirement.

10. An electronic device, comprising:
at least one processor; and
at least one memory, the at least one memory being coupled to the at least one processor and storing instructions executable by the at least one processor, the instructions, when executed by the at least one processor, c cause the electronic device to perform operations comprising:
obtaining a video generation indication, the video generation indication comprising an input video, at least one reference image, and first description information of a video to be generated, the at least one reference image comprising at least one subject;
determining a visual feature representation set based on a video feature representation corresponding to the input video and an image feature representation corresponding to the at least one reference image;
determining a text feature representation set based on a semantic feature representation corresponding to the at least one reference image and a text feature representation corresponding to the first description information; and
generating, with an attention mechanism and based on the visual feature representation set and the text feature representation set, a video comprising the at least one subject.

11. The electronic device of claim 10, wherein generating the video comprising the at least one subject comprises:
dividing a plurality of frames of the input video into a plurality of groups of frames;
determining, for each group of frames of the plurality of groups of frames, a corresponding combined visual representation in each of a query dimension, a key dimension, and a value dimension based on the image feature representation and a group of frame feature representations corresponding to the group of frames in the visual feature representation set;
determining a corresponding combined semantic representation in each of the query dimension, the key dimension, and the value dimension based on the text feature representation and the semantic feature representation in the text feature representation set; and
generating the video by applying the attention mechanism to the corresponding combined semantic representation and the corresponding combined visual representations determined respectively for the plurality of groups of frames.

12. The electronic device of claim 11, wherein determining the corresponding combined visual representation in each of the query dimension, the key dimension, and the value dimension comprises: for each dimension of the query dimension, the key dimension, and the value dimension:
determining, for each frame in the group of frames and based on a frame feature representation of the frame, a frame visual representation of the frame in the dimension;
determining, for each subject of the at least one subject and based on an image feature representation of a reference image comprising the subject, a subject visual representation of the subject in the dimension; and
combining, in a predetermined order, the frame visual representations respectively determined for the group of frames and the subject visual representations respectively determined for the at least one subject, to obtain a combined visual representation of the group of frames in the dimension.

13. The electronic device of claim 11, wherein determining the corresponding combined semantic representation in each of the query dimension, the key dimension, and the value dimension comprises: for each dimension of the query dimension, the key dimension, and the value dimension:
determining, based on the text feature representation, a description semantic representation of the first description information in the dimension;
determining, for each subject of the at least one subject and based on a semantic feature representation of a reference image comprising the subject, a subject semantic representation of the subject in the dimension; and
combining, in a predetermined order, the description semantic representation and the subject semantic representations respectively determined for the at least one subject, to obtain a combined semantic representation in the dimension.

14. The electronic device of claim 11, wherein the number of frames of each group of frames of the plurality of groups of frames is related to the number of the at least one subject.

15. The electronic device of claim 10, wherein the acts are performed in training of a diffusion model based on the attention mechanism, and the video generation indication comprises a training sample obtained by:
dividing an initial video into the input video and a reference video different from the input video;
extracting, by performing subject detection on the input video and the reference video, the at least one reference image from the reference video; and
constructing the training sample based on the at least one reference image, the input video, and description information for the input video.

16. The electronic device of claim 15, wherein a first scene corresponding to the reference video is different from a second scene corresponding to the input video.

17. The electronic device of claim 15, wherein extracting the at least one reference image from the reference video comprises:
generating, with a multi-modal model, the first description information for the input video and second description information for the reference video, the first description information and the second description information respectively comprising a description of a subject and a description of a scene in the corresponding video;
detecting whether there is a matching subject word in the first description information and the second description information; and
extracting, in response to detecting the matching subject word, the at least one reference image from the reference video based on the matching subject word.

18. The electronic device of claim 10, wherein the acts are performed in an inference stage, the first description information originates from a user input, and the acts further comprise:
determining, with a language model, whether the first description information meets a predetermined requirement, the predetermined requirement at least indicating a description of an appearance and a gesture of the at least one subject; and
updating, in response to the first description information failing to meet the predetermined requirement, the first description information based on the predetermined requirement.

19. A non-transitory computer-readable storage medium storing computer-executable instructions thereon, the computer-executable instructions, when executed by a processor, cause the processor to perform operations comprising:
obtaining a video generation indication, the video generation indication comprising an input video, at least one reference image, and first description information of a video to be generated, the at least one reference image comprising at least one subject;
determining a visual feature representation set based on a video feature representation corresponding to the input video and an image feature representation corresponding to the at least one reference image;
determining a text feature representation set based on a semantic feature representation corresponding to the at least one reference image and a text feature representation corresponding to the first description information; and
generating, with an attention mechanism and based on the visual feature representation set and the text feature representation set, a video comprising the at least one subject.

20. The non-transitory computer-readable storage medium of claim 19, wherein generating the video comprising the at least one subject comprises:
dividing a plurality of frames of the input video into a plurality of groups of frames;
determining, for each group of frames of the plurality of groups of frames, a corresponding combined visual representation in each of a query dimension, a key dimension, and a value dimension based on the image feature representation and a group of frame feature representations corresponding to the group of frames in the visual feature representation set;
determining a corresponding combined semantic representation in each of the query dimension, the key dimension, and the value dimension based on the text feature representation and the semantic feature representation in the text feature representation set; and
generating the video by applying the attention mechanism to the corresponding combined semantic representation and the corresponding combined visual representations determined respectively for the plurality of groups of frames.
